(19) United States
(12) Patent Application Publication
(10) Pub. No.: US 2024/0109573 A1
(43) Pub. Date: Apr. 4, 2024

(54) Mobile Cart with Adjustable Cargo Container

(71) Applicant: Hall Labs, LLC, Provo, UT (US)

(72) Inventors: David R. Hall, Provo, UT (US); Jerome Miles, Spanish Fork, UT (US); Quinn Riley, Provo, UT (US); Stephen Warren, Provo, UT (US)

(21) Appl. No.: 18/465,963

(22) Filed: Sep. 12, 2023

Related U.S. Application Data
(60) Provisional application No. 63/375,337, filed on Sep. 12, 2022.

(51) Int. Cl. B62B 3/02; B62B 3/00; B62B 3/08; B62B 5/00; G05D 1/02

(52) U.S. Cl. CPC B62B 3/022; B62B 3/005; B62B 3/08; B62B 5/004; B62B 5/0043; B62B 5/0053; G05D 1/0214

(57) ABSTRACT

A system for moving cargo is disclosed. The system includes a cart, which, in turn, includes a body with a battery compartment and a platform. The cart also includes wheels and a motor for driving the wheels. A battery is housed in the battery compartment for powering the motor. The system also includes a cargo carrier mounted on the platform. The cargo carrier includes a base, two side walls, and two end walls. At least one end wall or side wall is adapted to be moved between different positions to change the shape and/or size of the compartment.

### CROSS-REFERENCE TO RELATED APPLICATIONS

This application claims the benefit under 35 U.S.C. § 119(e) of U.S. Provisional Patent Application No. 63/375,337 titled “Mobile Cart with Adjustable Cargo Container” filed on 12 Sep. 2022, which disclosure is incorporated herein by reference in its entirety.

### TECHNICAL FIELD

The present disclosure relates to motorized carts. More particularly, it relates to a motorized utility cart adapted to carry a variety of cargos using adjustable cargo carriers.

### BACKGROUND

Motorized carts are used for a variety of purposes in different environments. Most are suited to only a few tasks in a very controlled environment. This limits their usefulness and value. These carts have fixed configurations that do not allow for adaptation to different functions. Typical carts require human effort to move and steer. They can also be inconvenient or difficult to transport requiring ramps and trailers or cargo space in a vehicle. What is needed is a motorized cart that is adaptable to different environments (e.g., indoor/outdoor) and different functions and is more readily transported.

### SUMMARY

In a first aspect, the disclosure provides a system for moving cargo. The system includes a cart, which, in turn, includes a body with a battery compartment and a platform. The cart also includes wheels and a motor for driving the wheels. A battery is housed in the battery compartment for powering the motor. The system also includes a cargo carrier mounted on the platform. The cargo carrier includes a base, two side walls, and two end walls. At least one end wall or side wall is adapted to be moved between different positions to change the shape and/or size of the compartment.

Further aspects and embodiments are provided in the foregoing drawings, detailed description, and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is an isometric view of a motorized portable cart attached to a vehicle with wheels raised according to the present disclosure.

FIG. 2 is an isometric view of the cart of FIG. 1 attached to a vehicle with wheels lowered.

FIG. 3 is an isometric view of an adapter hitch bar.

FIG. 4 is an isometric view of the cart of FIG. 1 with the adapter of FIG. 3 in a first position for raising the cart relative to a tow vehicle according to the present disclosure.

FIG. 5 is an isometric view of the cart of FIG. 1 with the adapter of FIG. 3 in a second position for lowering the cart relative to a tow vehicle.

FIG. 6 is a side isometric view of the cart of FIG. 1 with the platform elevated.

FIG. 7 is a side isometric view of the cart of FIG. 1 with the platform lowered.

FIG. 8 is a top view of the cart of FIG. 1 with the hitch bar extended.

FIG. 9 is a top view of the cart of FIG. 1 with the hitch bar extended on the other side of the cart than that shown in FIG. 8.

FIG. 10 is a top view of the cart of FIG. 1 with the hitch bar retracted for storage.

FIG. 11 is a side view of the cart of FIG. 1 with one pair of tires raised and the other pair lowered.

FIG. 12 is an isometric view of a second exemplary embodiment of a motorized portable cart attached to a vehicle hitch bar (vehicle not shown) with a barrow attachment.

FIG. 13 is an isometric view of the cart hitch bar connected to the vehicle hitch bar of the embodiments of FIG. 12.

FIG. 14 is an isometric view of the hitch system of FIG. 12 shown apart.

FIG. 15 is an isometric view of the hitch system of FIG. 12 with the cart body elevated to lift off the vehicle hitch.

FIG. 16 is an isometric view of the hitch system of FIG. 12 with the cart body lowered on to the vehicle hitch.

FIG. 17 is an isometric view of a hitch system for a motorized portable cart with electrical connectors.

FIG. 18 is another isometric view of the embodiment of FIG. 17.

FIG. 19 is an isometric view of the embodiment of FIG. 17 with the cart hitch bar elevated above the vehicle hitch bar.

FIG. 20 is an isometric view of the embodiment of FIG. 17 with the cart hitch bar lowered on to the vehicle hitch.

FIG. 21 is an isometric view of a motorized portable cart with two caster wheels and a barrow attachment.

FIG. 22 is a side view of the embodiment of FIG. 21.

FIG. 23 is another isometric view of the embodiment of FIG. 21.

FIG. 24 is isometric view of an exemplary embodiment of a cart with a cargo carrier component.

FIG. 25 is an isometric view of the embodiment of FIG. 24 with the cargo carrier in a second configuration.

FIG. 26 is an isometric view of the embodiment of FIG. 24 with the cargo carrier in a third configuration with cargo loaded.

FIG. 27 is an isometric view of the embodiment of FIG. 24 in the third configuration with additional cargo loaded.

FIG. 28 is an isometric view of the embodiment of FIG. 24 in a fourth configuration.

FIG. 29 is an isometric view of the embodiment of FIG. 24 with the cargo carrier tipped up to dump cargo.

FIG. 30 is a side plan view of the embodiment of FIG. 24 with the cart tipped.

FIG. 31 is a side plan view of the embodiment of FIG. 24 with the cart tipped and the cargo carrier tipped.

FIG. 32 is an isometric view of a motorized utility cart including a leash system and components attached above and below the cart platform according to the present disclosure.

FIG. 33 is an isometric view of the embodiment of FIG. 32 with an additional component stacked on top.

FIG. 34 is an isometric view of the embodiment of FIG. 32 with a barrow component stacked on top.

FIG. 35 is a side view of the embodiment of FIG. 34.

FIG. 36 is an isometric view of a cart with a control arm according to the present disclosure.

FIG. 37 is a side isometric view of a cart with a seat and basket according to the present disclosure.

FIG. 38 is an isometric view of a cart with a barrow tilted for dumping a load according to the present disclosure.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “level” is meant to refer to the horizontal plane (i.e., perpendicular to the force of earth's gravity) or the position of a surface or object relative to the horizontal. In discussing level, the terms “pitch”, “yaw”, and “roll”, as they are commonly used, may be used to describe turns and deviations from the horizontal plane and adjustments made to the orientation of a vehicle.

As used herein, “docking” refers to the act of bringing the cart into contact with a base, whether that base is stationary, such as a charging or storage station, or mobile, such as a vehicle to transport the cart. Docking may or may not involve securing the cart to the base.

As used herein, “hitching” is a subset of docking and refers to the act of bringing the cart into contact with and securing it to a mobile station, such as a vehicle to transport the cart.

As used herein, a “component” is any device or equipment that can be attached to the cart to enable the cart to perform a function or to make a functionality mobile. Components are “interchangeable” in the sense that they can be attached to and detached from the cart, such that one may replace another or be added onto another.

As used herein, a “hitch receiver” or “receiver” is any mechanism to which the hitch bar may attach to a docking station. In the case of a vehicle, the hitch receiver is typically the vehicle's tow hitch adapted for use with a ball hitch.

### Embodiments

The present disclosure relates to systems for moving cargo, which systems utilize motorized carts. More particularly, it relates to a motorized cart with a platform and a cargo carrier mounted to the platform.

The cart will be described first in a fair amount of detail, while the cargo carrier is described below.

In addition to the cargo carrier, the cart may be adapted for use with a variety of components that may include storage containers, work surfaces, personal support or transport devices, power tool, and functional equipment and machinery. It also relates to a motorized cart that is automated. The cart also includes an easy and convenient attachment to a docking station or a vehicle tow hitch (e.g., for charging or transportation). In various exemplary embodiments, a controller and one or more sensors are used to allow the vehicle to autonomously navigate around obstacles and reach destinations (e.g., to receive or deliver a load, to attach to a vehicle or docking station). The controller may also be configured to use GPS or other wireless signals to determine its position and navigate.

In various exemplary embodiments, the cart is powered by one or more electrical wheel motors. Each wheel motor is powered by one or more batteries, which are preferably rechargeable batteries.

In various exemplary embodiments, the cart is able to track its own location on a saved map and/or in relation to a starting position to which it may return. This may be accomplished through one or more of GPS, inertial sensors, and movement tracking. In various exemplary embodiments, the cart may use this information to navigate around a work site, or around a commercial, industrial, or residential building, or the like to perform a variety of tasks such as, but not limited to, landscaping (e.g., lawn mowing, leaf bagging, etc.), moving garbage cans, snow removal, transportation of materials or persons, or other tasks.

In various exemplary embodiments, the cart is adapted to dock with another apparatus or vehicle. In some preferred embodiments, docking may include connecting to an electrical source (e.g., for charging a cart battery). In preferred embodiments, docking may include a mechanical connection to a vehicle, entering a bay, mounting a trailer, etc. In a preferred embodiment, the cart is at least semi-autonomous and able to travel to the docking location and attach itself either in response to programming (e.g., work schedule, scheduled battery recharges, low battery alert) or user/operator instruction. In preferred embodiments, the docking procedure is fully automated requiring no action or supervision by the user/operator.

In various exemplary embodiments, the cart is adapted for direct attachment to a vehicle's hitch system for transportation. A hitch bar that is adapted to fit into the vehicle's hitch and slidably received in a sleeve or tube affixed to the body of the cart. The sleeve may be simply attached to the bottom of the cart's body or may be incorporated within the body itself. In a preferred embodiment, the sleeve traverses the width of the cart allowing the hitch bar to be extended from either side. In a preferred embodiment, the cart also connects electrically to the vehicle. This connection may be used to charge the battery and/or to operate running lights, turn signals, etc. on the cart if the corresponding lights on the vehicle are blocked or obscured by the cart or its contents. In preferred embodiments, the electrical connection is built into the mechanical connection. In other embodiments, a separate connection is used, which may be automatically or manually connected.

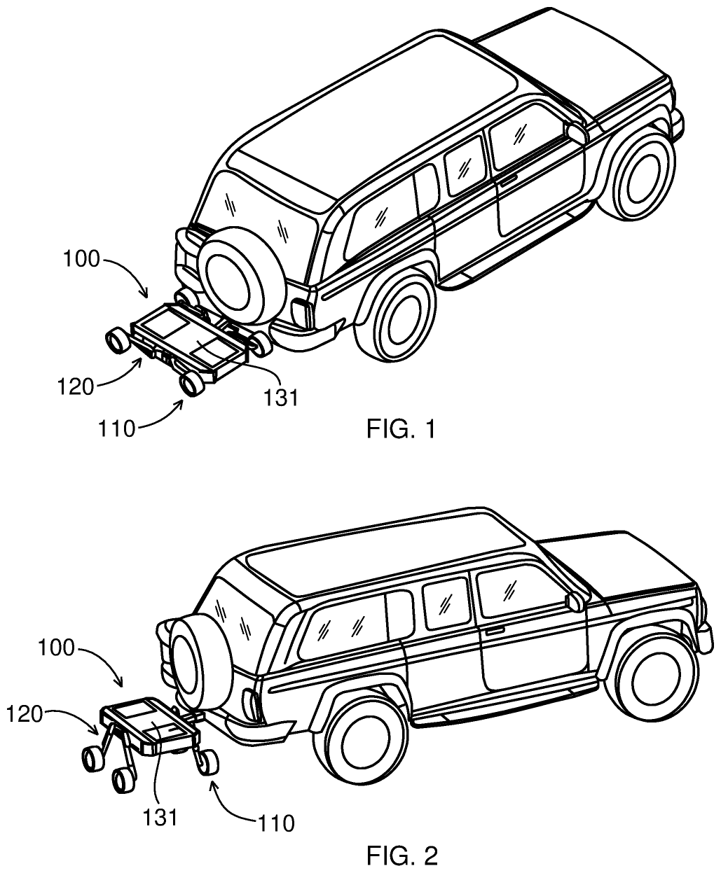

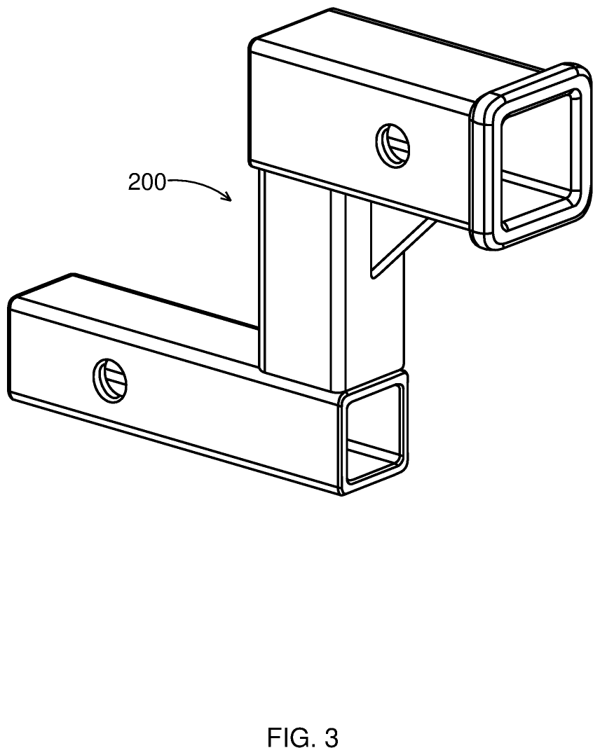

Now referring to FIGS. 1 and 2, an embodiment of a portable cart 100 is shown hitched to a vehicle. In FIG. 1, the cart's wheels 110 are raised off the ground for vehicle transport. In FIG. 2, the cart's wheels 110 are lowered to the ground. In preferred embodiments, the wheels 110 may be raised and lowered (i.e., the platform may be lowered and raised) to facilitate easy mounting of the cart 100 to a vehicle hitch.

In various exemplary embodiments, the cart 100 has four wheels 110, each of which are attached to the end of an arm 120 (or leg) that is articulatably (e.g., pivotally) attached to the cart's body or frame 130. In preferred embodiments, each of the arms 120 is attached to an actuator 121 (e.g., a motor) that is used to articulate the arm 120 such that the wheel 110 is raised or lowered (i.e., the platform 131 may be lowered and raised) relative to the body 130.

Now referring to FIG. 3, a vertically offset adapter 200 to adjust the height of the cart relative to the vehicle tow hitch receiver is shown. In a preferred embodiment, the adapter 200 is used to attach the cart to tow vehicles with high or low hitch receivers. In various exemplary embodiments, the adapter 200 is designed to attach to the hitch bar on one end and to the tow vehicle hitch receiver on the other end. In a preferred embodiment, the adapter 200 is connected using a pin, bolt, or other fastener. In a preferred embodiment, the locking mechanism is automated and locks into place once the system is in position.

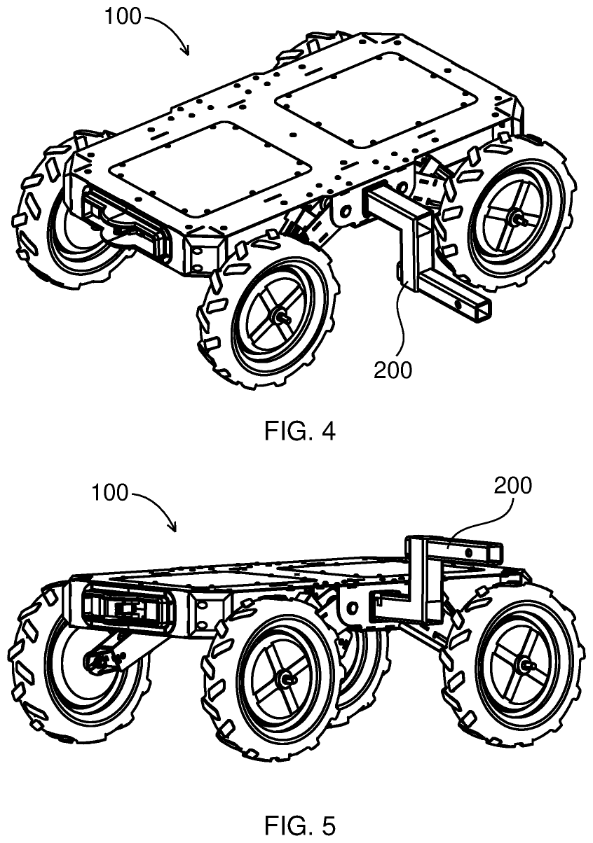

Now referring to FIGS. 4 and 5, the vertically offset adapter 200 is shown attached to the cart 100 in one each of two positions. In FIG. 4, the adapter 200 is in position to raise the height of the cart 100 relative to the tow vehicle. In FIG. 5, the adapter 200 is in position to lower the position of the cart 100 relative to the tow vehicle. Different embodiments of the adapter may have different dimensions, particularly as to the height offset achieved. The preferred offset distance may vary based on vehicle hitch height (i.e., vehicle height) and the diameter of the wheels on the cart.

In the case of a low-riding vehicle, the adapter 200 may be used to attach the cart 100 at a sufficient height off the ground to ensure that the cart's wheels 110 do not touch the ground. This may be especially important on uneven surfaces or when crossing a dip, such as a storm drainage channel or when entering/exiting a parking lot or driveway. The necessary clearance may depend on the choice of tires (i.e., wheel diameter) for the cart.

In the case of an elevated tow vehicle, the adapter makes it possible to attach the cart 100 to a hitch receiver that it is higher off the ground than the cart 100 has the capability to elevate. It may also facilitate loading and unloading the cart 100 while attached to the tow vehicle.

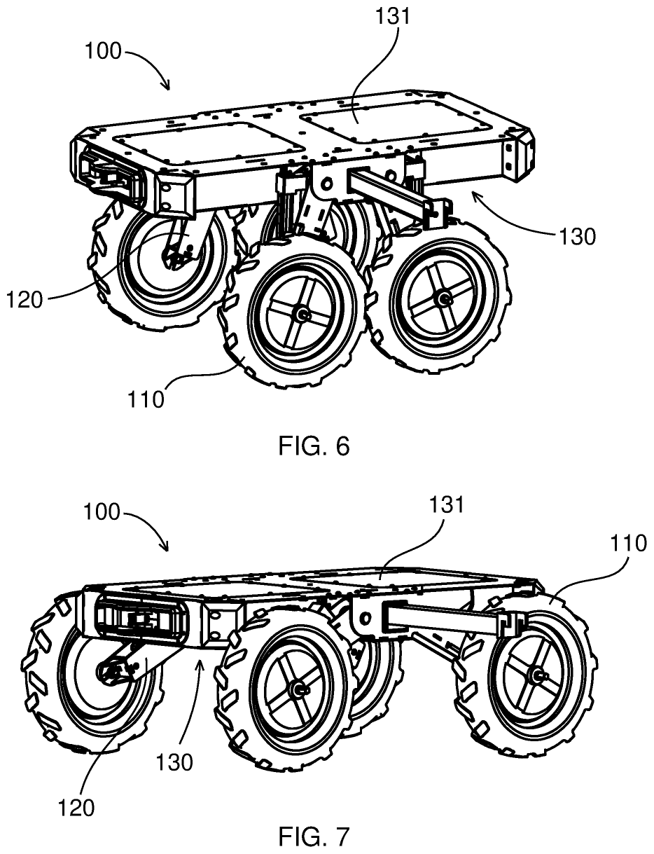

Now referring to FIGS. 6 and 7, cart 100 is shown with platform 131 raised and lowered. In addition to raising and lowering the hitch for attachment to a vehicle, the platform may be raised or lowered to facilitate addition of components to the cart, loading and unloading cargo, and for optimal movement. In various exemplary embodiments, the cart's wheels 110 are mounted on arms 120 rotatably attached to the cart body 130. In various exemplary embodiment, the arms include at least one actuator, such as a piston with adjustable length, and a fixed length member. In another embodiment, the arms comprise a linear actuator, such as a hydraulic piston or screw drive, that allows the length of the arm to be adjusted.

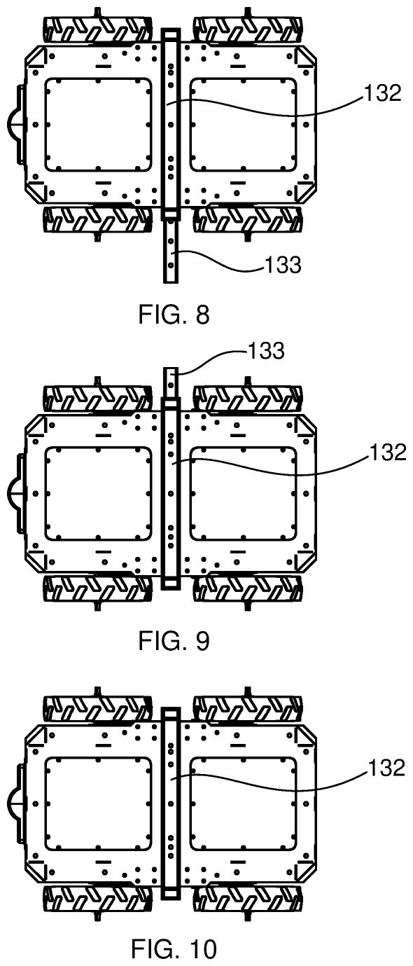

Now referring to FIGS. 8-10, the cart is shown with an adjustable hitch bar 133 in a variety of positions. In a preferred embodiment, the cart includes a tube sleeve 132 and a hitch bar 133 that slidably fits therein. The hitch bar is adapted to fit into the hitch mount of a tow vehicle in the same manner that a ball hitch or the like would be attached to the vehicle.

In FIG. 8, the attachment hitch bar 133 is extended out from the receiving member. In FIG. 9, the hitch bar 133 is less extended. In FIG. 10, the hitch bar is fully retracted into the sleeve. In each case, the hitch bar 133 is fixedly locked in place with a pin, bolt, or other fastener. In a preferred embodiment, the locking mechanism is automated. This allows for storage of the hitch bar 133 when not in use and for extension of the hitch bar 133 to a plurality of lengths as appropriate for the tow vehicle. Many tow vehicles have spare tires, bicycle racks, or the like mounted on the back of the vehicle necessitating a longer hitch bar to enable connection to the vehicle without removing the spare tire or other item.

In some exemplary embodiments, the attachment hitch bar 133 is manually adjusted and locked in place. In other exemplary embodiments, the attachment hitch bar 133 is mechanically adjusted either manually (e.g., by hand or using a hand crank) or is automated (e.g., moved by a motor or other actuator).

In various exemplary embodiments, the system is able to automatically keep the platform 130 level. However, in some situations, it may be advantageous for the cart to deviate from level. For example, when the cart is engaging or disengaging with a vehicle tow hitch, it is important for the cart and tow vehicle to be on the same level (i.e., same angle) so that the hitch bar may readily slide into the vehicle hitch (or the cart onto the hitch bar).

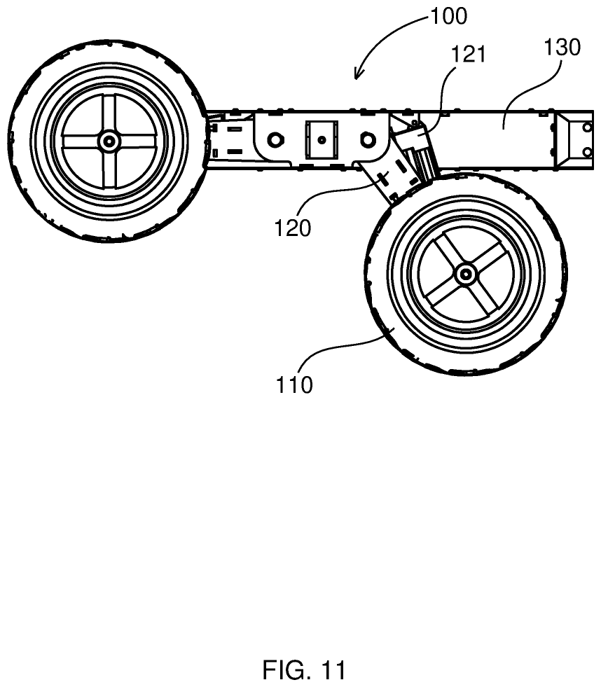

Now referring to FIG. 11, cart 100 is displayed with one pair of wheels raised and the other lower. In a preferred embodiment, sensors are able to detect when the platform is not horizontal and control the pivot arm actuators 121 to adjust the wheels 130 to maintain it at level with the horizontal plane. In a preferred embodiment, the wheels 130 are designed to be able to climb uneven terrain and obstacles such as curbs, steps, stairs, etc. and adjust the tires 130 relative to the platform to maintain it at level. This may be beneficial for passengers or cargo carried on the cart. In various exemplary embodiments, the pivot arm actuators are consistently on a low-powered lifting movement that is insufficient to actually raise the cart due to its weight but that will lower a wheel that is not in contact with the ground (i.e., when the cart crosses a dip).

As shown in FIG. 11, the arm actuator 121 is a linear actuator (e.g., a piston or screw drive) pivotally attached at a first end to the body 130 at a point near to where the arm 120 is attached to the body 130. The second end of the actuator 121 is attached to the arm, preferably at or near the attachment of the arm 120 to the wheel 110. Extending or retracting the linear actuator 121 articulates the wheel 110 away from or toward the body 130, raising and lowering the cart.

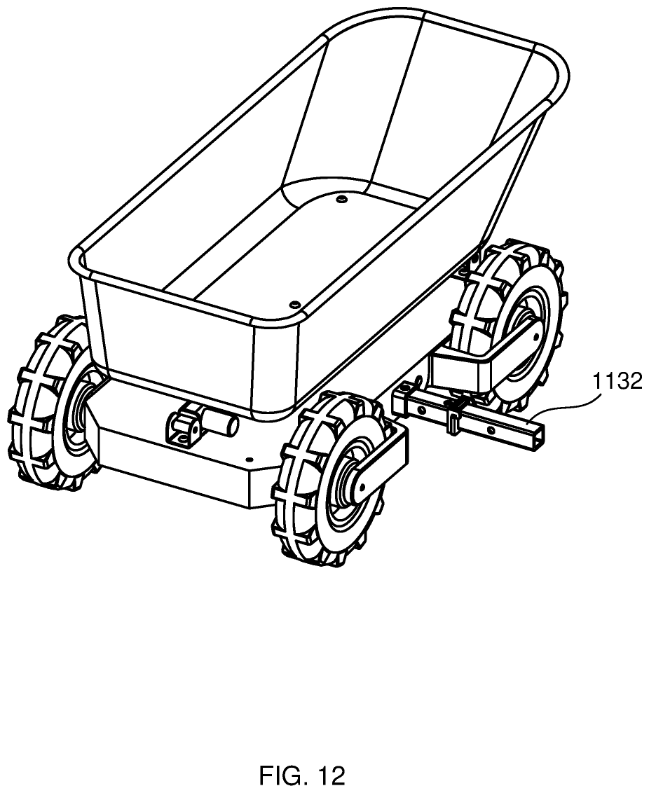

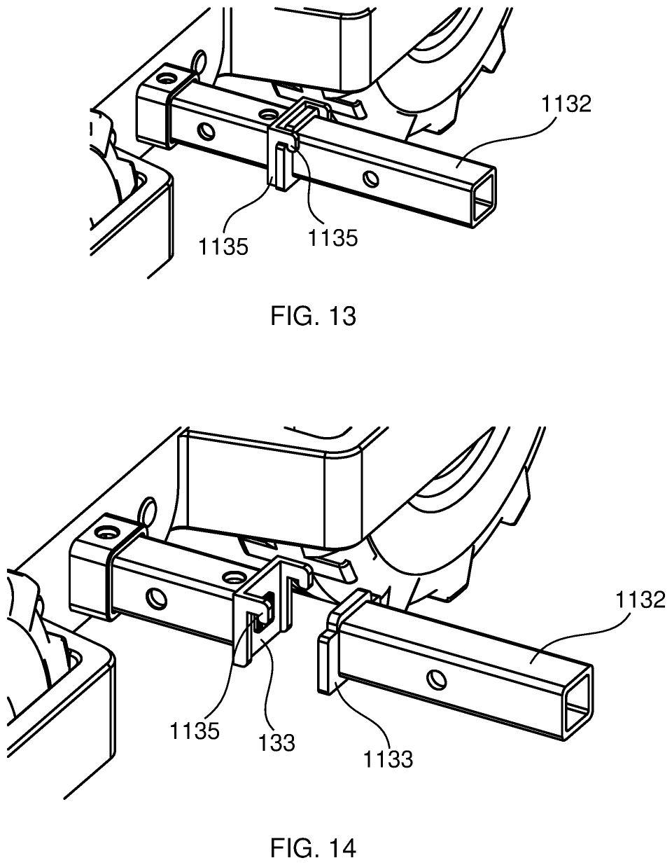

In various exemplary embodiments, an adapted vehicle hitch is used to attach the cart. Referring to FIGS. 12-16, a preferred embodiment includes a hitch bar 1132 that may be conventionally attached to a vehicle at one end. The hitch bar 1132 includes a flange 1133 on the other end. The attachment hitch bar 1132 includes a bracket 1134 comprising two downward facing channels 1135 (e.g., hooks) adapted to engage with the flange 1133.

In various exemplary embodiments, the arms 120 themselves can be extended and retracted. In this way, the cart has an even greater height adjustment range. Such greater range can be advantageous, particularly where the cart is adapted to climb stairs and the like. In these embodiments, the arms 120 may include arm extension actuators (e.g., a piston or screw) that can extend and retract to lengthen or shorten the total length of the arms. This increases the height to which the platform may be raised and the tilt angles that can be achieved and can also provide a longer wheelbase for better stability.

In the exemplary embodiment shown in FIG. 12, a dumpable container 300 (e.g., a barrow) is mounted on the cart. As described elsewhere, the cart is adapted to carry a variety of components capable of serving a wide variety of purposes and functions.

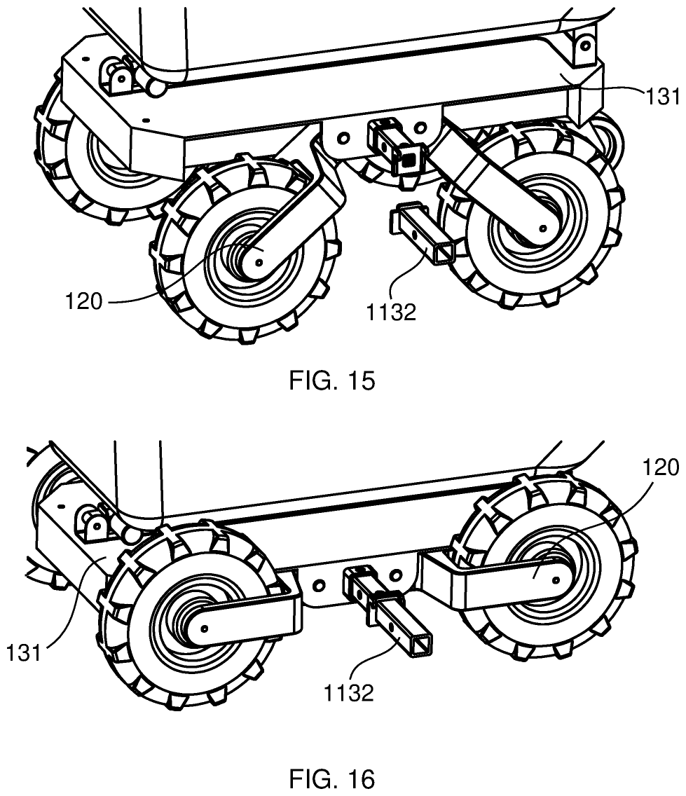

Referring to FIG. 15, the cart is shown with platform 131 raised (i.e., with the wheels lowered). Raising the platform lifts the attachment hitch bar above the vehicle hitch bar disengaging the bracket from the flange. In various exemplary embodiments, the system includes a latching pin or arm that further secures the attachment hitch bar to the vehicle hitch bar. In preferred embodiments, the latching pin automatically engages when the attachment hitch bar and vehicle hitch bar are connected.

Referring to FIG. 16, the cart is shown with platform 131 lowered (i.e., with the wheels raised). Lowering the platform brings the attachment hitch bar down to the vehicle hitch bar engaging the bracket onto the flange.

In various exemplary embodiments, the cart is designed to connect with docking stations, which includes transportation vehicle hitches. In a preferred embodiment, the connection may be a secure mechanical connection, such as described above for a vehicle hitch. In a preferred embodiment, the connection also includes an electrical connection. The electrical connection may provide current for charging a cart battery. It may also activate lights on the cart, such as taillights, signal lights, brake lights, etc., that mimic those on the vehicle. This may be necessary in situations where the vehicle and cargo obstruct or obscure vehicle lights.

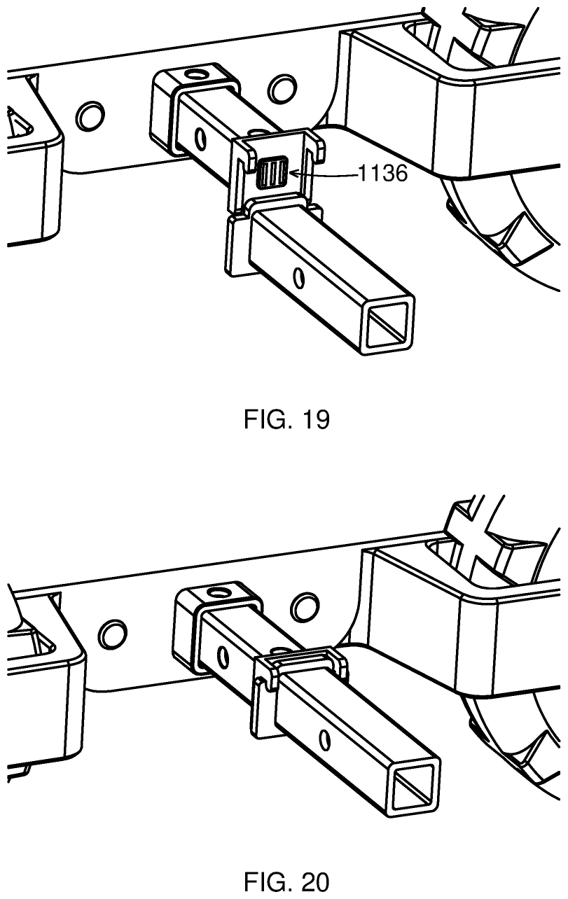

Referring to FIGS. 17-20, an exemplary embodiment of a connection including an electrical connection is shown. The mechanical connection is the same type as shown above in FIGS. 12-16. The cart hitch bar includes electrical connectors. In a preferred embodiment, three electrical connectors (e.g., positive, negative, and ground) are provided. The vehicle hitch includes matching electrical connectors.

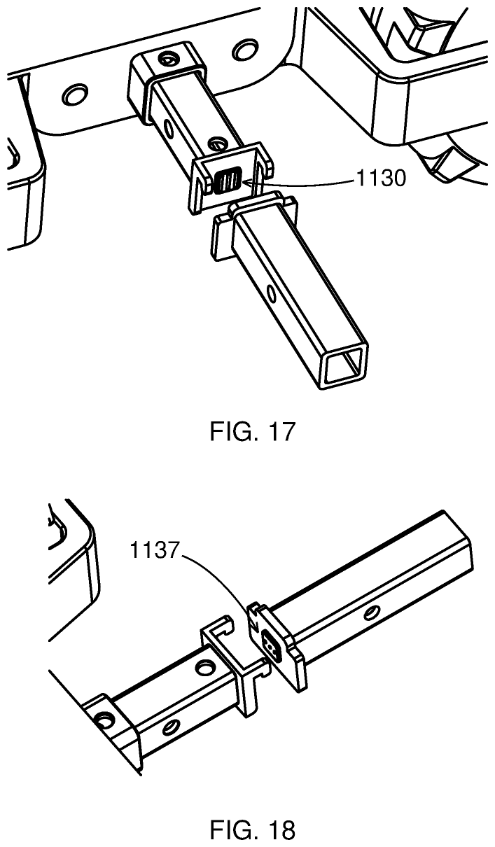

In a preferred embodiment, the electrical connectors on a first connector 1136 are arranged in vertical lines (see FIG. 17). The electrical connectors on a second connector 1137 are smaller pins (see FIG. 18). This arrangement provides tolerance for the electrical connectors to engage without a precise vertical alignment fit. It also helps to maintain the connection when the vehicle is jostled by bumps, dips, etc. during transport. In various exemplary embodiments, there is one or more additional latching or locking mechanisms holding the hitch bars together. These may include a bar or latch extended from the cart hitch bar under or into the vehicle hitch bar.

In various exemplary embodiments, one or more electric motors are used to power one or more tires. In a more preferred embodiment, motors are included in each of two or four of the wheels for separately driving each wheel. In preferred embodiments, the motors that actuate the wheels are located in the wheel hub. In preferred embodiments, geared hub motors are used in two or more of the wheels. Motors or other actuators are also included for actuating the pivot arms to raise and lower the wheels or cart platform. In a preferred embodiment, the cart includes at least one battery that provides power to the motors and actuators. In a more preferred embodiment, the battery is a rechargeable battery.

Preferably, the cart system includes a charging station for the cart. Such a charging station includes a supply of power and the appropriate electrical and mechanical connections.

In various exemplary embodiments, the cart is equipped to connect to components on racks by positioning itself under the component and then raising itself into contact with the component, securing the component, and raising itself to lift the component off the rack. A component may be above a bay known to the cart. A bay may also function as a cart storage space and include an electrical connection to which the cart connects for charging the battery. Components may also be stored at a known location and engaged by the cart approaching them, engaging them, and lifting them off the ground. This includes components that attach on top of the platform (e.g., barrow), under the platform (e.g., lawnmowers, leaf baggers), and/or to the end or hang over the edge of the platform (e.g., snow blowers or plows).

In various exemplary embodiments, at least two of the wheels are omni-wheels (omnidirectional wheels) or, more preferably, Mecanum wheels. The preferred Mecanum wheel is a tireless wheel, with a series of rubber coated rollers obliquely attached to the circumference of the rim. The rollers have an axis of rotation that is 45° to the wheel plane and 45° to the axle line. Each Mecanum wheel is an independent non-steering drive wheel with its own powertrain, preferably a hub motor. When spinning, the wheel generates a propelling force perpendicular to the roller axle. These forces can be vectored into a longitudinal and a transverse component in relation to the vehicle. The chart below illustrates how the direction of rotation of each wheel determines the direction of the vehicle:

The use of omni-wheels or Mecanum wheels enables the widest range of motion for the cart, including the ability to move sideways. Sideways movement is particularly useful for docking and undocking with a transport vehicle hitch. To detach, the wheels are lowered sufficient to take the weight of the cart and the cart moves parallel to the hitch shaft to pull away from the tow vehicle and separate from the tow hitch receiver. To attach, the cart is motored into position behind the vehicle and the body elevated to match the hitch shaft to the level of the tow hitch. The cart then moves to engage the hitch shaft with the tow hitch receiver.

In alternative embodiments, simpler wheels, such as with pneumatic tires are used. Steering with simple wheels is accomplished by independently controlling the wheel motors. For example, tank or skid steering can be utilized.

In various exemplary embodiments, the cart is directed by turning the wheels on one side of the vehicle faster than the wheels on the other side of the vehicle, by turning the wheels on only one side, or by rotating the wheels on each side in opposite directions (i.e., skid steering). The greater the difference in rotation, the tighter the turn including rotating in place. One undesirable effect of this is that the wheels can rub or grind on the ground, which can damage flooring or plants (e.g., grass lawns). For use on such surfaces, two of the motorized wheels may be replaced by caster wheels.

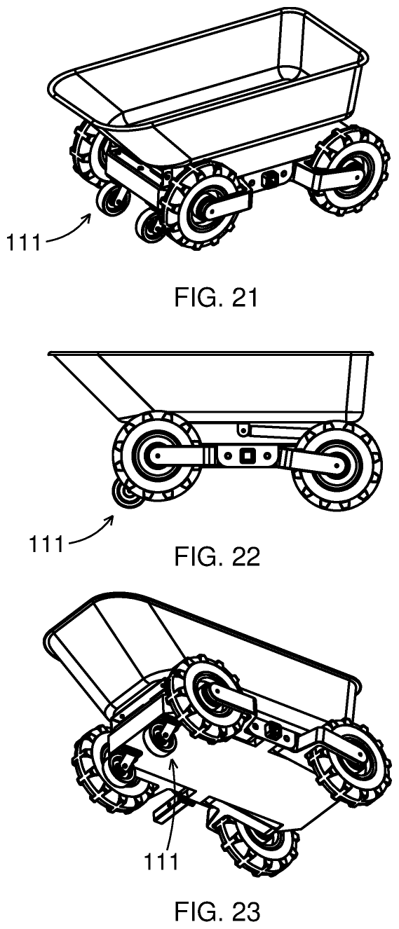

Now referring to FIGS. 21-23, the cart includes a pair of caster wheels 111. In some embodiments, the casters 111 may be raised or lowered from under the cart. In other embodiments, the caster wheels 111 are fixedly attached and only come into contact with the ground when wheels are raised above the level of the caster wheels. In a preferred embodiment, the casters 111 are detachably attached to the cart and may be easily removed when not needed for the cart's intended use. In one embodiment, a pair of caster wheels 111 are located at about the corners at one end of the cart. In some embodiments, the cart includes a second pair of caster wheels 111.

In such an embodiment, the cart can move without the need for skid steering.

Rotating the motorized wheels at different rates will cause the cart to turn without skidding on the floor. In other embodiments the cart includes four casters. With four casters, the cart may be manually pushed and steered, which may be desirable in some environments and/or loadings.

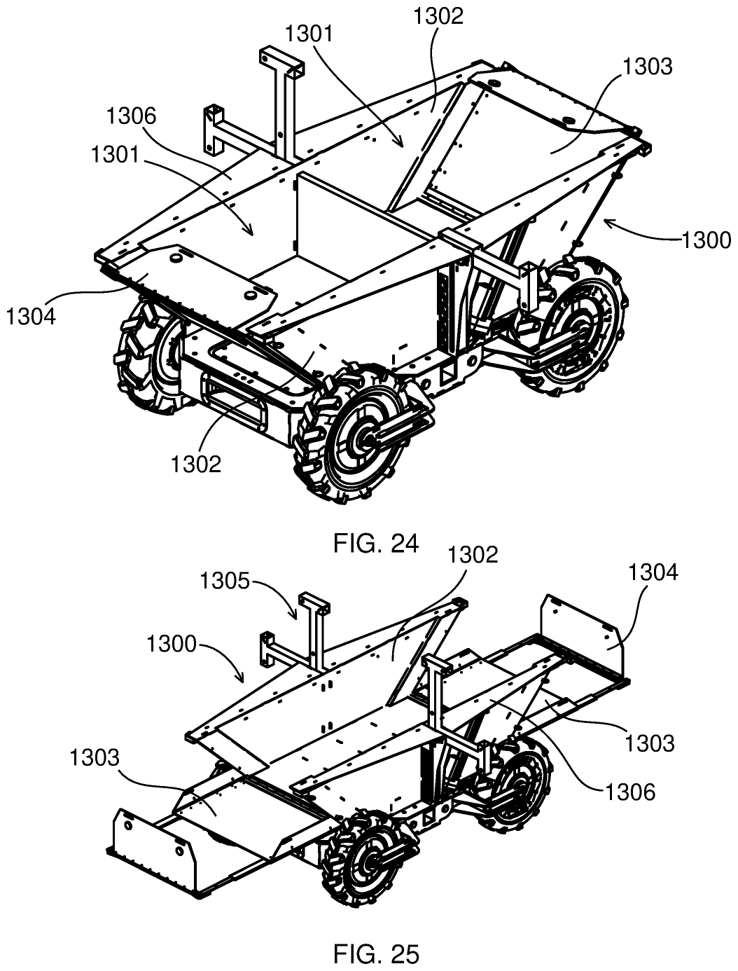

Now turning to the cargo carrier aspect of the invention, the cart is equipped with cargo carrier in the form of an adjustable barrow or container 1300 capable of different configurations for differently shaped or sized loads. Now referring to FIG. 24, an exemplary embodiment of a cargo carrier attachment 1300 is shown in one configuration. In this configuration, there are two compartments 1301 able to receive cargo, including loose cargo like gravel. Because the side walls 1302 rise above the height of the center divider and the end pieces, the cart is also adapted to carry longer objects, like lumber, above the barrow. In FIG. 24, the end walls are in raised (i.e., upward angled) and retracted positions.

Now referring to FIGS. 25-27, the configuration of the cargo carrier 1300 is altered by laying out the end pieces to extend the length of the flat bottom and create stops 1304 at the end. As shown in FIG. 25, this configuration is useful for carrying objects like lumber and/or boxes. In a preferred embodiment, the end pieces are adjustable (i.e., between a retracted position or extended to varying distances) to vary the length of the cargo carrier.

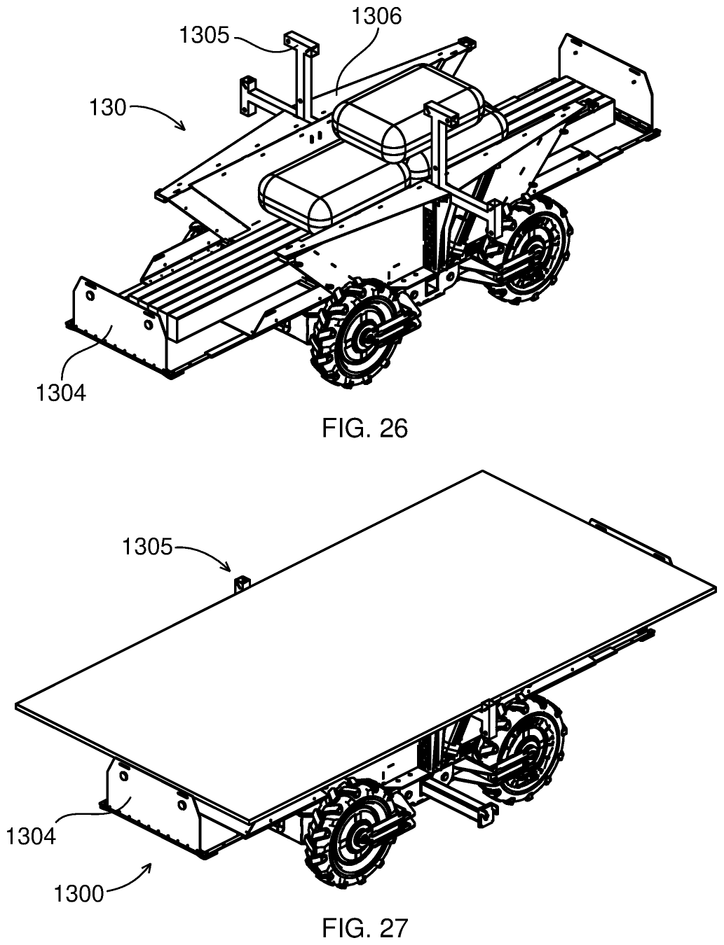

Referring now to FIG. 26, an exemplary embodiment of the cargo carrier attachment includes side arms 1305 that may be lifted to the level of the top of the sidewalls. The side walls are equipped with shelves 1306 that are at the same height.

Now referring to FIG. 27, the configuration of FIG. 26 is shown carrying a large, thin material such as plywood or sheets of drywall. When used in this way, it is advisable to use the divider shown in FIG. 24, if possible, for a given load, as an additional support in the middle of the load. In FIGS. 25-27, the end walls are shown in lowered and extended positions.

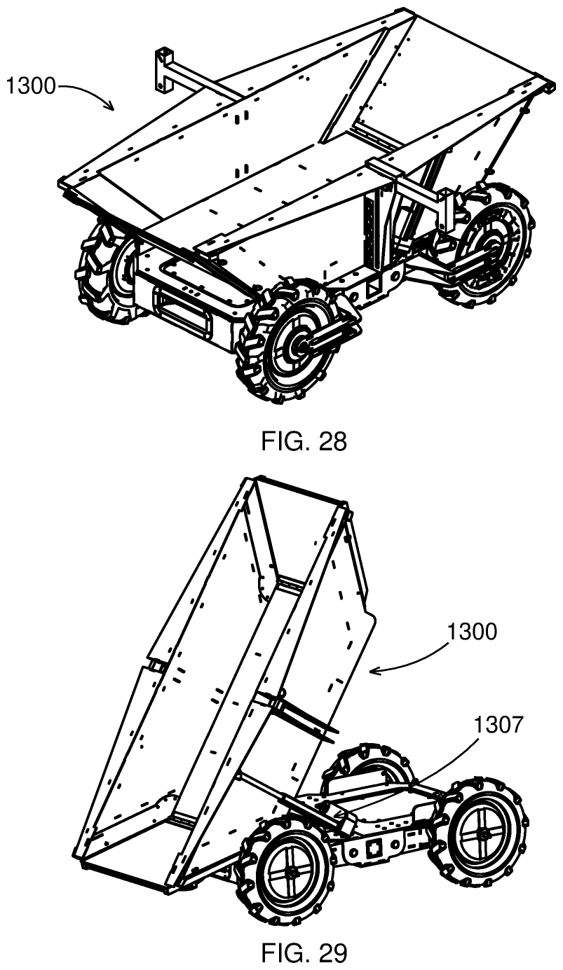

Now referring to FIGS. 28-29, the cargo carrier 1300 is shown in a “wheelbarrow” configuration particularly suited to carrying loose solids like dirt, sand, and gravel. The cargo carrier comprises a single container with slanted ends. In FIG. 29, actuator 1307 is used to raise the barrow cargo carrier 1300.

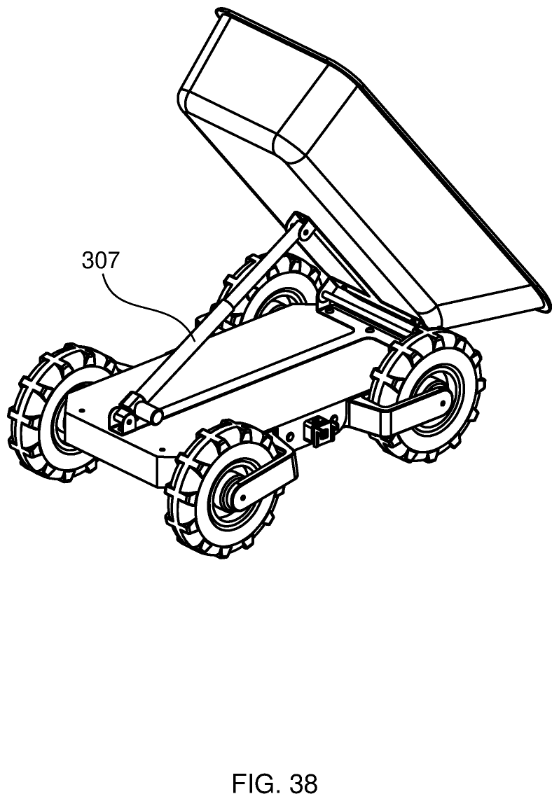

Now referring to FIG. 29, the cargo carrier 1300 is connected to the cart such that it is capable of dumping its cargo. In a preferred embodiment, a piston or similar actuator 1306 (not shown) between the cart and the cargo space is included to lift the carrier and dump its cargo. FIG. 38 illustrates another actuator 307 design for lifting an end of the carrier.

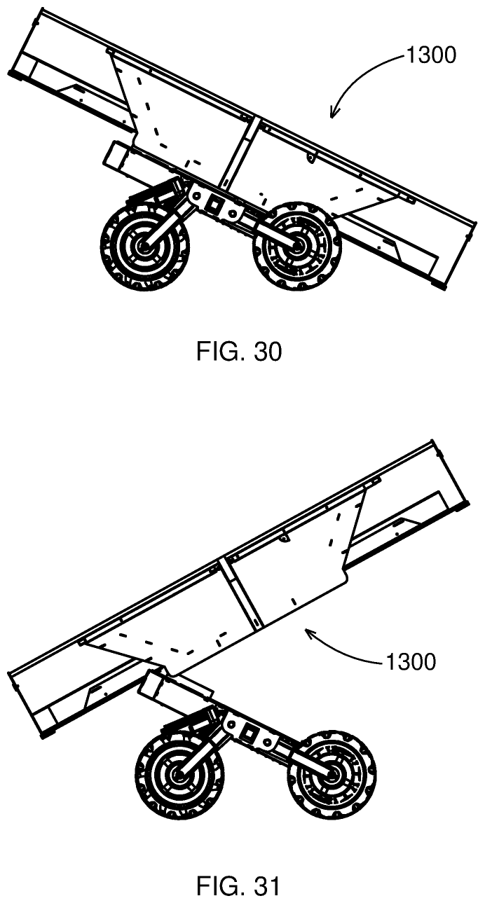

Now referring to FIGS. 30-31, another method of tipping the cargo container 1300 is shown. The wheels on one end are raised and the others are lowered. This raises one of the extended ends higher off the ground.

Now referring to FIG. 31, and the cargo carrier is tipped to lower the extended end toward the ground (mechanism for tilting not shown). Because that end was first raised, the cargo carrier can be tipped without the end hitting the ground at a shallow angle.

In various exemplary embodiments, the wheels may be removed and replaced with different size or type wheels. The wheels may vary in diameter, width, or tread type depending on the desired use or environment (e.g., indoor/outdoor, floor surface, load weight). Currently, pneumatic tires, with a tread suitable for navigating indoors and outdoors, are preferred.

In other exemplary embodiments, the arms on which the wheels are mounted are designed for easy removal for switching wheels. In some such embodiments, the arms are attached to the cart with one or more pins, bolts, or other fasteners.

In various exemplary embodiments, the cart is able to follow a user. In some embodiments, the cart may be drawn by a leash that is able to detect a distance and direction of a handle, which is held by the user. This information is used to track the user's location at all times to record and then follow the same path as the user (possibly avoiding obstacles or surfaces on which it should not travel).

In various exemplary embodiments, the cart includes a controller that operates the motors to steer the vehicle. The connection may be wired or wireless. In a preferred embodiment, the controller is able to record and store routines (i.e., how to navigate paths, climb stairs), including navigating turns and raising/lowering the wheels/platform to maintain the platform at level climbing stairs and curbs or other crossing other obstacles or non-level surfaces.

In various exemplary embodiments, the system includes a processor, a memory module, and a position module. In preferred embodiments, the position module records adjustments made by the cart to maintain a level condition over a given path. Further, the processor is configured to provide instructions to the controller to make the same adjustments when the cart travels the same path or to make the adjustments in reverse order when returning along a previously traveled path.

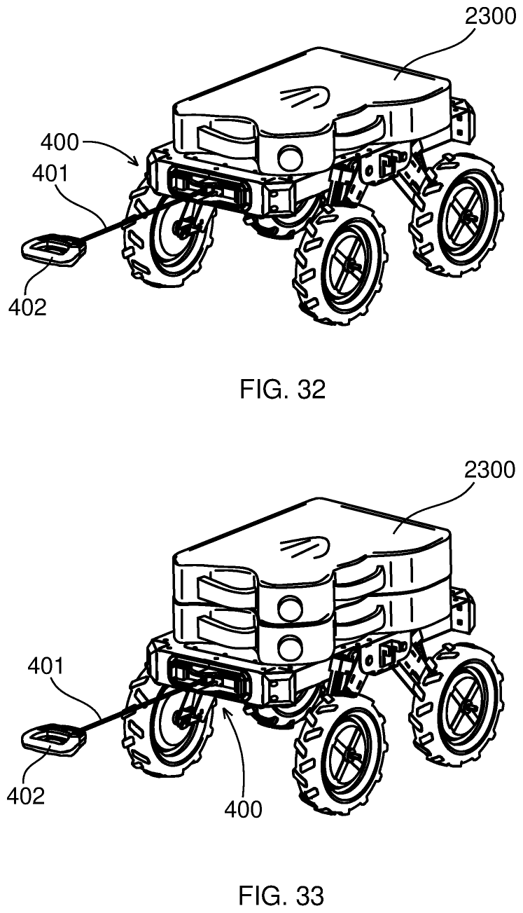

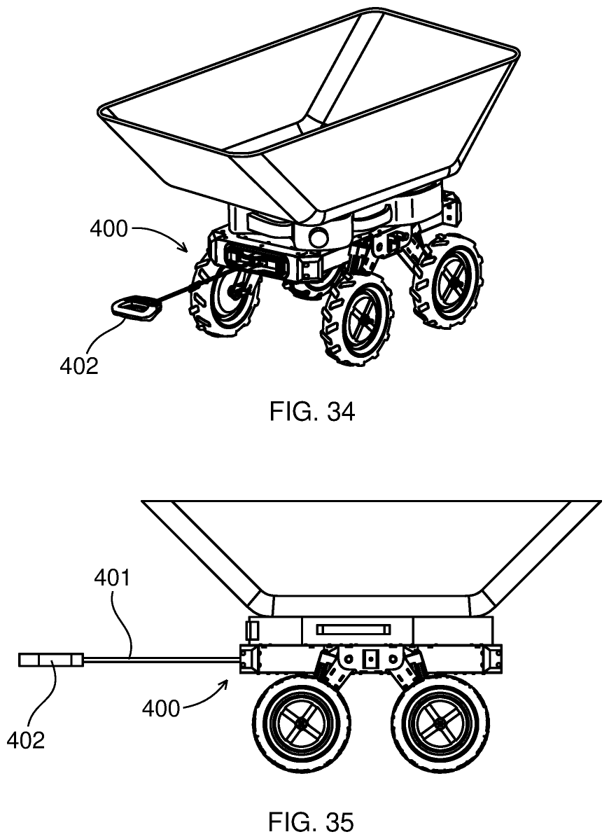

In various exemplary embodiments, a remote-control device is connected to the controller to instruct on how the cart should move. In preferred embodiments, the remote-control device connects wirelessly to the controller. In a more preferred embodiment, the cart includes a docking station for the remote-control device. The docking connection may include a charging connection for a remote-control battery and a wired data connection to the controller. In less preferred embodiments, the remote control is part of a cart leash handle of the type shown in FIGS. 32-35 and discussed below.

Now referring to FIGS. 32-35, an embodiment of a cart with a leash control system 400 is shown. In various exemplary embodiments, the leash system 400 uses a cable 401 of known length around a spool (not shown). In a preferred embodiment, the leash 400 is retracted when not in use. In preferred embodiments, the spool is incorporated with a leash handle 402 and is not on the cart body. In a preferred embodiment, an encoder records the rotations of the spool and send that data to the controller. The distance from the spool to the handle may be measured based on the number of spool rotations when the leash is unspooled, which may be unspooled less than its entire length. The spool may communicate wirelessly with the controller or via wired connection in the leash.

In a preferred embodiment, the leash is pivotally attached to the cart. This connection rotates as the leash is pulled different in directions from the cart. In various exemplary embodiments, the leash system allows the handle to be pulled out until a minimum safe distance, which may be chosen by the user, is reached. At this point, pulling the leash out more instructs the cart to begin moving forward. As the leash is pulled more, the cart increases speed until a maximum speed is reached. If the leash is allowed to retract back past the trigger point, the cart will stop moving. In preferred embodiments, the leash is allowed to extend until it reaches a maximum length (this may be the total length of the leash or be selectively locked at a shorter length).

When the fully extended or locked leash is pulled on, the “slider” is pulled forward. A magnet on the “slider” interacts with at least one magnetic sensor in a linear array of magnetic sensors. The array of sensors detects the position of the “slider” and accelerates the cart based on that position. If the “slider” is pulled to its maximum position, the cart accelerates to its maximum speed.

In various exemplary embodiments, the leash passes through a pivoting channel. A magnet on the channel rotates through a range of positions based on the angle of the leash to the cart. An array of magnetic sensors detects the position of the magnet to determine the direction of the leash. This is used to turn the cart either at the time the leash is moved in active steering mode or in intelligent steering mode at a point calculated based on leash length and angle to follow the user's path of travel (as described in greater detail below).

In various exemplary embodiments, the cart has two travel modes. In an active control mode, the cart responds immediately to movements of the handle. This is most useful in situations where the user needs to closely control the cart and not be followed by the cart (e.g., when storing the cart or hitching it to a two vehicle). In an intelligent travel mode, the cart uses data from the control system to follow the path traveled by a user (e.g., turning where and not when the user turns). In various exemplary embodiments, the cart may also be capable of being put in park and/or neutral modes.

In various exemplary embodiments, the cart's control system may be placed in a forward or a reverse mode much like a car with an automatic transmission is placed in drive or reverse. In various exemplary embodiments, when in reverse, the system works in opposite faction from forward. In some embodiments, the cart will stop when the “slider” is fully extended and reaches maximum speed when it is fully retracted.

In some embodiments an encoder records partial rotation of the spool and sends this data to the controller. The data from the spool and from the leash connection are used to constantly determine and track the movement of the handle and, thereby, the movement of the user.

In other exemplary embodiments, the system may track a user by tracking a device carried by the user (e.g., a phone or remote) using accelerometers and other sensors or systems, such as GPS, to track and follow the user.

In various exemplary embodiments, the system also includes a manual controller (e.g., one or more buttons and/or joysticks) used to direct the cart. This may be incorporated into the leash handle or may be separate therefrom.

In various exemplary embodiments, the cart records the position of the handle as it is moved by the user to calculate a path to follow the user. In a preferred embodiment, the cart attempts to follow the path of the user, as determined by handle position, rather than always moving directly in the direction of the user/handle. This allows the cart to avoid obstacles avoided by the user and to keep it from cutting across corners when the user changes directions.

In various exemplary embodiments, the system is able to detect changes in unspooled leash length as user starts, stops or pauses, and changes in pace and react accordingly. Referring again to FIG. 32 the cart is shown with a container 2300 mounted on top. In FIG. 33, it is shown with two containers 2300 stacked one on top of the other.

In various exemplary embodiments, the cart has a forward mode and a reverse mode. In forward, or normal, mode, the cart moves forward in response to tension on the leash. When placed in reverse mode, the cart reverses when tension on the leash is relaxed by the user.

In various exemplary embodiment, the cart platform is designed to be a support for a variety of components. In various exemplary embodiments, the platform includes a plurality of connection points for components of different sizes or configurations. In various exemplary embodiments, the plurality of connection points includes multiple points where the component is secured to the platform. The plurality of connection points also includes electrical connections for power and data. Not all components will need or use all the connection points. For example, simple storage containers may not need electrical or data connections while heated or cooled containers may need to be powered and have settings to be set and controlled. Also, by way of example, a chair may not use all the mechanical connection points because its footprint is smaller than that of the platform.

The components may be attached above or below the platform and may extend over the edges of the platform (e.g., a snowplow attachment) The components may include one or more of seats, chairs, beds, toolboxes, tabletops, worktables, open or closed storage compartments (which may be heated or refrigerated), robotic arms, fuel tanks, water tank, oxygen tank, barrows, garbage can grapplers, lawn mowers, snowplows, snow blowers, skid plates for moving garbage cans and other containers, strollers, office chairs, human carriers (e.g., converting the cart into a motorized scooter or bed), and the like. In various exemplary embodiments, components may also be attached to the underside of the cart. In some embodiments, a space in the cart is reserved for connections between components above and below the cart. The connections may be fluidic, electronic, or mechanical. For example, a lawnmower attached below the cart may be driven by a motor attached above the cart body via a shaft and/or other mechanical connections.

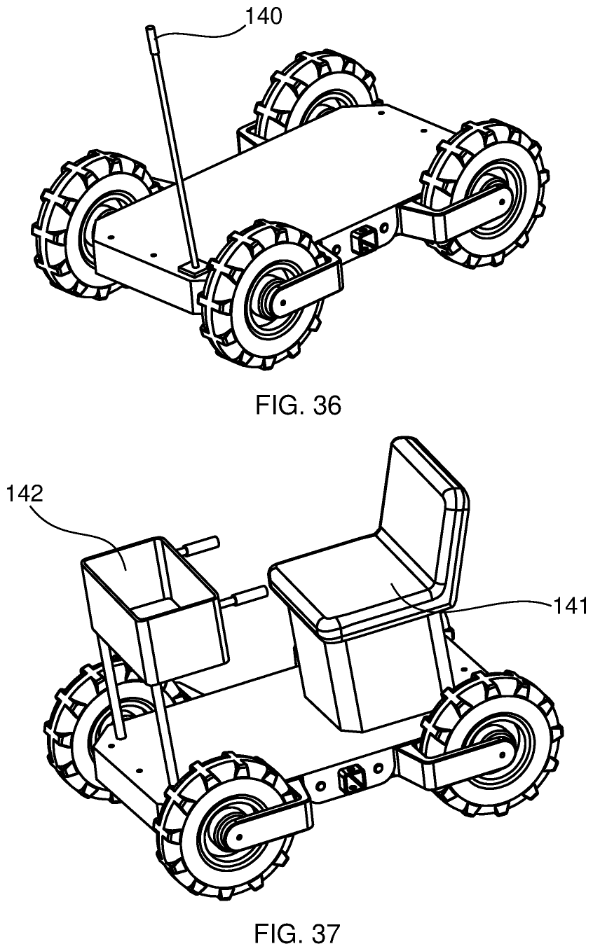

In various exemplary embodiments, as exemplified in FIG. 36, the cart is equipped with a control stick. An operator pushes the control stick in the desired direction of movement and the cart moves accordingly. In embodiments like that in FIG. 36. the control stick is adapted for use by an operator walking along with the cart or standing thereon. In a preferred embodiment, the system includes a safety mechanism to prevent the cart from moving because of incidental or accidental contacts with the control stick. For example, the stick handle could include a trigger or switch that must be held down or sensors for detecting a user's hand for it to operate. In other exemplary embodiments, a smaller joystick, which may or may not be affixed to the cart, may be used (e.g., when used as a remote).

In a preferred embodiment, as shown in FIG. 37, the cart is equipped to have a component such as a seat 141 and a basket 142. The seat preferably rotates at its base to facilitate a person's getting on and off. In some embodiments, the seat is equipped with a belt or harness to keep the rider safely in place. A basket is preferably provided for carrying items for the rider. An expanded platform, such as shown in FIG. 25 may be used to create sufficient space for a second seat such as the type shown in FIG. 37.

In other embodiments, the cart is equipped with a component that includes a work surface, such as a desk with a tablet or other computing device. In this way, a person with otherwise limited mobility can move about an office or other workspace and have the tools needed to work in that space. Other components for an office space include displays, projects, audio equipment, and the like.

In still other embodiments, the cart is equipped with a component that includes a convertible chair, i.e., that is able to convert from an upright chair for working to a reclining chair and even to a bed. As such, the cart can be used to facilitate movement and care for those with limited capabilities.

In yet other embodiments, the cart is equipped to transport and facilitate the use of various tools at a worksite. For example, a table saw component can be attached to the cart, so that the table saw can be moved to and from a worksite and moved around the worksite. The battery of the cart may be used to power the table saw. Other powered hand tools, such as drills, nail guns, and handheld saws may also be transported on the cart. These powered hand tools can be powered by a power cord plugged into the cart or can be recharged on the cart for cordless operation. Preferably, the cart is also equipped with at least one clamp for holding workpieces, such as a board, while being cut, drilled, etc.

In various exemplary embodiments, the cart includes one or more sensors used by the cart for self-location, navigation, observation, and target identification. In various exemplary embodiments, the cart utilizes GPS, inertial sensors, locally and/or remotely stored maps, and tracking to monitor and track its own position and to determine a path to a destination. In various exemplary embodiments, the cart utilizes cameras, radar, sonar, LiDAR, and the like to detect and avoid obstacles and to detect and navigate to a destination. In some embodiments, the cart is able to receive and process signals from a beacon or the like on a vehicle or docking station in order to locate the source.

In various exemplary embodiments, the cart includes one or more sensors to detect the location of a docking station. In preferred embodiments, the cart includes one or more sensors to determine the orientation (e.g., pitch, roll, and yaw) of a receiver or connector on the docking station in order to position itself for docking and move itself into a docked position. The docking location may also include visual markers or targets, which may be designed for this purpose or may have another purpose (e.g., vehicle license plate). In various exemplary embodiments, the controller includes, or is able to remotely access, AI capability for analyzing camera images to identify and analyze people and objects that it encounters. In some embodiments, the docking station includes sensors for determining its own orientation (e.g., pitch, roll, and yaw) and wirelessly communicates that information to the cart.

In various exemplary embodiments, the cart is able to store information on its location and movements for use in navigation. This may be stored locally in the cart, on a remote controller, and/or on a cloud service.

In various exemplary embodiments, the cart is programmed to send a notification in the event of problems. These problems may include unexpected shift or loss of cargo detected by weight sensors, an obstructed destination, or lack of a path to a destination.

Preferably, the cart includes controls on itself for controlling movement and other functions. These controls may include steering wheels or levers, handle bars, buttons, switches, etc. Preferably, the cart is also equipped to receive voice commands. Preferably, the cart is further equipped to receive wireless commands, such as from a smartphone or a smart home system, such as Alexa®, Google Home® or Apple Homepod®.

Various safety features are preferably built into the cart. For example, proximity or other types of sensors can be used to prevent collisions between the cart and other objects. Such sensors may make use of ultrasonic, infrared, optical, radar, lidar or other technology. The level sensors may also be used to avoid tipping conditions.

In various exemplary embodiments, the cart monitors one or more of voltage drop in the arm actuators, current draw in the arm actuators, and wheel motor velocity and uses this data to calculate the weight of the cart and any contents. In some embodiments, the cart includes one or more weight sensors capable of measuring the weight of a load placed on top of the cart.

The cart described herein is well-suited to use in combination with the system disclosed in U.S. patent application Ser. No. 17/476,309, entitled “Package Delivery System with Robots for Last Distance,” filed Sep. 15, 2021. The cart of the present disclosure can be used as the robot for taking packages the last distance, for example from a delivery truck to the final destination at a residence or business.

All patents, published patent applications, and other publications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for moving cargo, the system comprising:
a cart, comprising:
a body comprising a battery compartment and a platform;
wheels;
a motor for driving the wheels; and
a battery housed in the battery compartment for powering the motor; and
a cargo carrier mounted on the platform, comprising:
a base, two side walls, and two end walls;
wherein at least one end wall or side wall is adapted to be moved between different positions to change the shape and/or size of the compartment.

2. The system of claim 1, wherein the end walls further comprise:
a first section and a second section;
wherein the first section is movable between a position parallel to the base and a position angled upward from the base.

3. The system of claim 1, wherein the end walls further comprise a ledge in proximity to an edge of the end wall and wherein the side walls further comprise a ledge in proximity to an edge of the side wall.

4. The system of claim 1, further comprising:
at least one actuator connected to the cart at a first end and to the storage compartment at a second end;
wherein the cargo carrier is pivotally attached to the cart;
wherein the actuator raises an end of the cargo carrier to facilitate dumping out the cargo carrier.

5. The system of claim 1, wherein the cart comprises:
four arms, each articulatably attached at a first end to the body;
four wheels, each connected to a second end of one of the four arms; and
four arm actuators, each configured to articulate one of the four arms such that the wheels are moved closer to or further from the body.

6. The system of claim 5, wherein the four arm actuators each comprises a linear actuator pivotally attached to the body at a first end and to the arm at a second end.

7. The system of claim 6, wherein the arm actuators each comprises a piston.

8. The system of claim 5, wherein each first end of the four arms is pivotally connected to the body.

9. The system of claim 9, wherein the four arm actuators are each configured to articulate one of the four arms to move a second end of the arm toward or away from the body, wherein each of the four arm pivot actuators is independently controlled by the controller.

10. The system of claim 5, wherein the cart comprises four motors each adapted to drive one of the four wheels.

11. The system of claim 10, wherein the four motors are each located within the hub of the wheel driven by the motor.

12. The system of claim 5, wherein the four wheels comprise omni-wheels.

13. The system of claim 5, wherein the four wheels comprise Mecanum wheels.

14. The system of claim 1, wherein the battery is a rechargeable battery.

15. The system of claim 1, further comprising a navigational system, comprising:
one or more sensors adapted to detect obstacles around the cart, and a controller receiving data from the one or more sensors and navigating the cart to avoid contact with obstacles.

16. The system of claim 15, wherein the navigational system further comprises a GPS system in communication with the controller whereby the controller is able to locate the cart on a map and navigate to a destination.

17. The system of claim 1, further comprising a system for attaching the cart to a carrier vehicle, comprising:
a cart docking attachment arm;
a controller;
four arms, each pivotably attached at a first end to the body;
four wheels, each connected to a second end of one of the four arms;
four arm actuators, each configured to pivot one of the four arms such that each wheel can be moved closer to or further away from the body;
wherein the controller adjusts the height of the cart by pivoting one or more of the four arms; and
at least two motors, each configured to rotate one of the four wheels, each independently controlled by the controller, whereby the controller can move the cart and control the yaw of the cart by rotating one or more of the four wheels;
whereby the cart can be moved into an appropriate position and orientation for connecting the docking attachment arm to a docking station by the controller selectively pivoting the arms and rotating the wheels; and
wherein the docking attachment arm comprises connections for electricity or data.

18. The system of claim 1, wherein the end walls are adjustable between a retracted position and an extended position.

19. The system of claim 18, wherein the end walls are also adjustable between a raised position and a lowered position.

20. The system of claim 1, wherein the end walls are adjustable between a raised position and a lowered position.
